(19) United States
(12) Patent Application Publication
(10) Pub. No.: US 2006/0140061 A1
(43) Pub. Date: Jun. 29, 2006

(54) Plate-like holding structure and electronic timepiece having the same

(76) Inventor: Taichi Haga, Chiba-shi (JP)

Correspondence Address: ADAMS & WILKS, 17 BATTERY PLACE, SUITE 1231, NEW YORK, NY, 10004, US

(21) Appl. No.: 11/319,107

(22) Filed: Dec. 27, 2005

(30) Foreign Application Priority Data
Dec. 28, 2004 (JP) 2004-380862

(51) Int. Cl. G04B 37/00; G04B 29/00

(52) U.S. Cl. 368/88; 368/319

(57) ABSTRACT

To provide a plate-like holding structure capable of fixing both of an oscillator cabinet and a battery by a minimum size and an electronic timepiece having the same. A plate-like holding structure of an electronic timepiece is a holding structure constituted by a slender leaf spring as a whole mounted to a machine frame of a timepiece main body to be substantially orthogonal to a main face of the timepiece main body and to be extended along a direction of extending the main face, including a battery holding portion brought into press contact with a battery at one end portion thereof and including an oscillator cabinet holding portion brought into press contact with a cabinet of an oscillator at other end portion thereof and constituted such that a middle portion of the two holding portions is supported by a fulcrum portion supported by the machine frame main body.

### BACKGROUND OF THE INVENTION

1. Field of the Invention

The present invention relates to a plate-like holding structure for holding a cabinet of an oscillator and a battery of a timepiece and an electronic timepiece having the same.

2. Description of the Prior Art

In an electronic timepiece, there is proposed a constitution in which a plate-like holding structure made of a metal including a main body portion extended in parallel with a main face of a timepiece main body is fixed to a machine frame by thermal calking, a pin, a screw or the like at the main body portion, a main body portion or a cabinet of a quartz oscillator is pressed to a main plate to fix at a quartz oscillator main body supporting spring portion extended from the main body portion and a battery plus terminal portion extended by being folded to bend in right angle relative to the main body portion is pressed to a peripheral face of a plus pole of a battery (JP-A-2000-81491 and JP-A-11-44774). Such a battery plus terminal is more or less provided with a function of positioning to fix the battery in a battery containing recess portion. Further, there is proposed a constitution in which a main body portion or a cabinet of a quartz oscillator is contained in an oscillator containing groove portion of a main plate and the oscillator cabinet is pressed into the groove by a press plate in a shape of a leaf spring extended substantially in parallel with a main face of a timepiece main body on a surface side of a train wheel bridge to thereby fix the oscillator cabinet (JP-A-2001-74869).

However, according to the plate-like holding structure of JP-A-2000-81491, respective portions are constituted by being branched and extended from the main body portion and therefore, a spring portion for supporting the quartz oscillator main body and a spring portion of the battery plus terminal portion need to be provided with spring forces independently from each other and sizes thereof are liable to be enlarged to provide sufficient spring forces. Further, in a case of an electronic timepiece of an analog type, the main body portion of the plate-like holding structure is extended in parallel with the main face of the timepiece main body over substantially the entire timepiece main body including a train wheel mechanism at a center portion thereof and therefore, it is difficult to avoid that the main body portion of the plate-like holding structure occupies an large occupying area.

Further, there is proposed a battery connecting structure in a shape of a leaf spring constituted to be pressed to a battery at one end thereof and pressed to a circuit board at other end thereof (JP-A-7-169451).

The invention has been carried out in view of the above-described problem and it is an object thereof to provide a plate-like holding structure capable of fixing both of an oscillator cabinet and a battery by a minimum size and an electronic timepiece having the same.

### SUMMARY OF THE INVENTION

In order to achieve the above-described object, a plate-like holding structure of the invention is a holding structure comprising a slender leaf spring as a whole mounted to a machine frame of a timepiece main body to be substantially orthogonal to a main face of the timepiece main-body and to be extended along a direction of extending the main face, wherein the holding structure includes a battery holding portion brought into press contact with a battery at one end portion thereof and includes an oscillator cabinet holding portion brought into press contact with a cabinet of an oscillator at other end portion thereof and constituted such that a middle portion of the two holding portions is supported by a fulcrum portion supported by a machine frame main body.

According to the plate-like holding structure of the invention, the slender leaf spring is mounted to the machine frame of the timepiece main body to be substantially orthogonal to the main face of the timepiece main body and to be extended along the direction of extending the main face and therefore, an occupying area in view from the direction of extending the main face of the main face of the timepiece main body can be minimized. Further, the plate-like holding structure of the invention is constituted by the slender leaf spring, including the battery holding portion brought into press contact with the battery at the one end portion and including the oscillator cabinet holding portion brought into press contact with the cabinet of the oscillator at the other end portion and is constituted such that the middle portion of the two holding portions is supported by the fulcrum portion supported by the machine frame main body and therefore, a force required for pressing to hold the oscillator cabinet can be utilized for pressing to hold the battery as it is and a force required for pressing to hold the battery can be utilized for pressing to hold the oscillator cabinet as it is. Therefore, the slender leaf spring constituting the plate-like holding structure may only be provided with a characteristic capable of providing a desired pressing force as a whole and therefore, fabrication thereof is also facilitated. Here, naturally, the machine frame arranged with the oscillator cabinet and the battery is formed with a receiving portion or a projected portion (including a peripheral wall portion of a recess portion) for supporting the pressing forces received by the oscillator cabinet and the battery in the direction of extending the main face of the timepiece main body by a press portion related to the plate-like structure. The machine frame may be a main plate, a train wheel bridge, or other portion stationarily placed to a case.

Further, although the plate-like structure may be constituted by a shape of a flat plate so far as a main face of the plate is substantially orthogonal to the main face of the timepiece main body, typically, the respective press portions are folded to bend or bent relative to the middle portion to be adapted to press to hold the battery and press to hold the oscillator cabinet.

The middle portion of the two press portions of the plate-like structure is supported by the fulcrum portion supported by the machine frame main body. Here, a total of the plate-like structure is operated as a single leaf spring. However, when desired, the middle portion of the plate-like structure may be held by the fulcrum portion to some degree. In that case, the force required for pressing to hold the oscillator cabinet and the force required for pressing to hold the battery are partially supported by the fulcrum portion by which the middle portion of the two press portions is supported by the machine frame main body. However, at least a portion of a moment caused by a reaction force of the force of pressing the battery is supported by the oscillator cabinet, at least a portion of a moment caused by a reaction force of the force of pressing the oscillator cabinet is supported by the battery, however, one is supported stably by presence of other as described above.

According to the plate-like holing structure of the invention, when the plate-like holding structure is directly supported by the machine frame, typically, the middle portion is supported by the machine frame of the timepiece main body by being pinched by a groove portion or between projected portions of the machine frame of the timepiece main body. Such a simple support structure can be constituted because the plate-like holding structure is arranged such that the main face of the plate-like holding structure becomes substantially orthogonal to the main face of the timepiece main body.

According to the plate-like holding structure of the invention, when the plate-like holding structure is indirectly supported by the machine frame, typically, the middle portion includes a winding stem engaging portion engaged with a winding stem and is supported by the machine frame by way of the winding stem. In this case, typically, the winding stem engaging portion is constituted by a winding stem positioning and engaging portion formed at one side edge of the middle portion, elastically engaged with a small diameter portion contiguous to an abacus bead shape portion having a large diameter of the winding stem and elastically deformed by the abacus bead shape portion to permit to pass through the abacus bead shape portion in bringing in and out the winding stem. In this case, the winding stem engaging portion is provided with both functions of a function of positioning the winding stem and a function of providing the fulcrum of the plate-like holding structure. However, the plate-like holding structure may indirectly be supported by other timepiece part other than the winding stem.

An electronic timepiece of the invention includes the plate-like holding plate holding structure constituted as described above.

The electronic timepiece of the invention may be constituted such that the electronic timepiece further includes a reset lever deviating spring portion for exerting a deviating force from a nonreset position to a reset position to a reset lever at one side edge thereof.

### BRIEF DESCRIPTION OF THE SEVERAL VIEWS OF THE DRAWINGS

A preferred form of the present invention is illustrated in the accompanying drawings in which:

FIG. 1 is a plane explanatory view of a main body portion of an electronic timepiece according to a preferable embodiment of the invention having a plate spring structure as a plate-like holding structure according to a preferable embodiment of the invention (a state of removing a train wheel bridge);

FIG. 2 is an explanatory view of a section taken along a line II-II of FIG. 1;

FIG. 3 show arrangements of a plate spring structure, FIG. 3A is an explanatory view of a section taken along a line IIIA-IIIA of FIG. 1, FIG. 3B is a plane explanatory view of a portion viewed in a IIIB-IIIB line direction of FIG. 3A, FIG. 3C is an explanatory view of a section taken along a line IIIC-IIIC of FIG. 3A, and FIG. 3D is an explanatory view of a section of a modified example of FIG. 3C similar to FIG. 3C;

FIG. 4 is a perspective explanatory view of the plate spring structure of FIG. 1;

FIG. 5 show states of supporting a quartz oscillator cabinet of FIG. 1, FIG. 5A is an explanatory view of a section taken along a line VA-VA of FIG. 1, FIG. 5B is an explanatory view of a section of a modified example of FIG. 5A similar to FIG. 5A, FIG. 5C is an explanatory view of a section of other modified example of FIG. 5A similar to FIG. 5A, FIG. 5D is an explanatory view of a section of still other modified example of FIG. 5A similar to FIG. 5A, and FIG. 5E is an explanatory view of a section taken along a line VE-VE of FIG. 1;

FIG. 6 is a plane explanatory view when the electronic timepiece of FIG. 1 is brought into a nonreset state;

FIG. 7 is a plane explanatory view when the electronic timepiece of FIG. 1 is brought into a reset state; and

FIG. 8 show modified examples of the electronic timepiece of FIG. 1, FIG. 8A is a plane explanatory view similar to FIG. 1 shown in a state of omitting a train wheel or the like, FIG. 8B is an explanatory view of a section taken along a line VIIIB-VIIIB of FIG. 8A.

### DETAILED DESCRIPTION OF THE PREFERRED EMBODIMENTS

Next, a preferable embodiment of the invention will be explained based on a preferable embodiment shown in attached drawings.

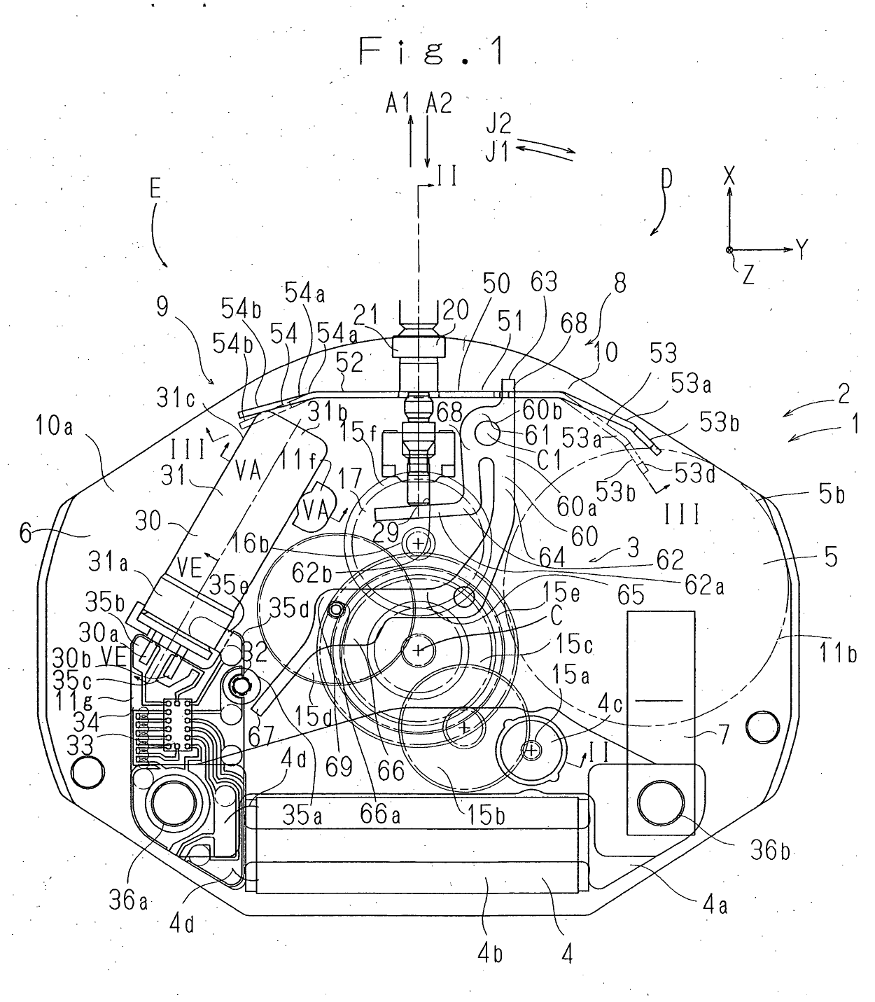

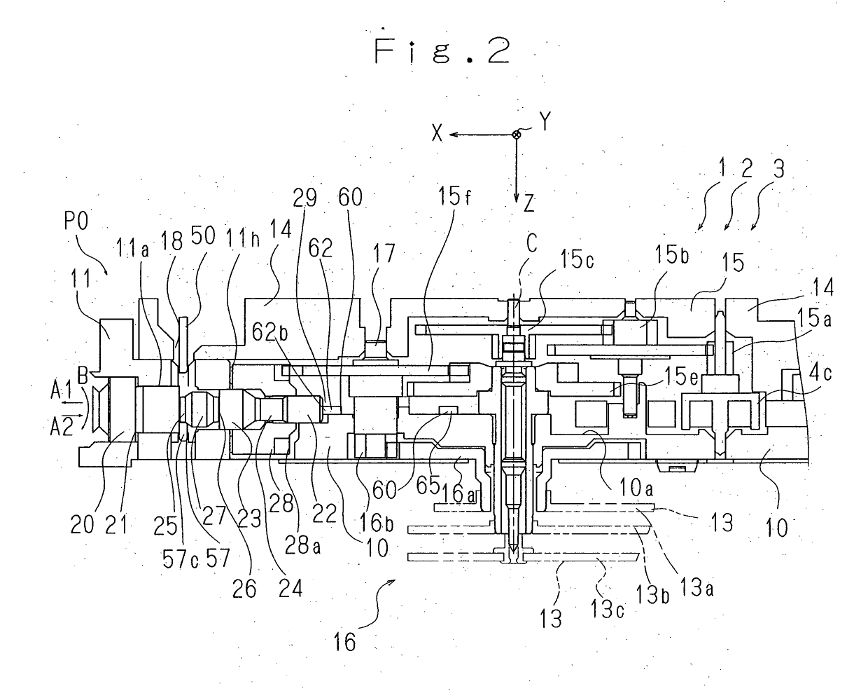

A timepiece main body 2 of an electronic timepiece 1 is provided with a main plate 10 constituting a machine frame. In the following, a three-dimensional coordinates system fixed to the main plate 10 is adopted for simplifying the explanation. Here, X direction is constituted by a direction A1 of drawing a winding stem 20 (3 o'clock side), Y direction is constituted by a right direction (12 o'clock side) in FIG. 1 and Z direction is constituted by a depth direction of the drawing orthogonal to the drawing. Z direction coincides with a side having a dial 12 (refer to FIG. 2). Here, XY plane is in parallel with a main face of the timepiece main body 2 and a direction of Z axis is a direction orthogonal to the main face of the timepiece main body 2. In FIG. 1 and FIG. 2, notation C designates a rotational center axis line of time display hands 13 (that is, hour hand 13a, minute hand 13b, second hand 13c) connected to a train wheel mechanism 3 of the timepiece main body 2. Here, the timepiece main body 2 indicates a portion excluding an exterior portion of a case or the like from the timepiece 1.

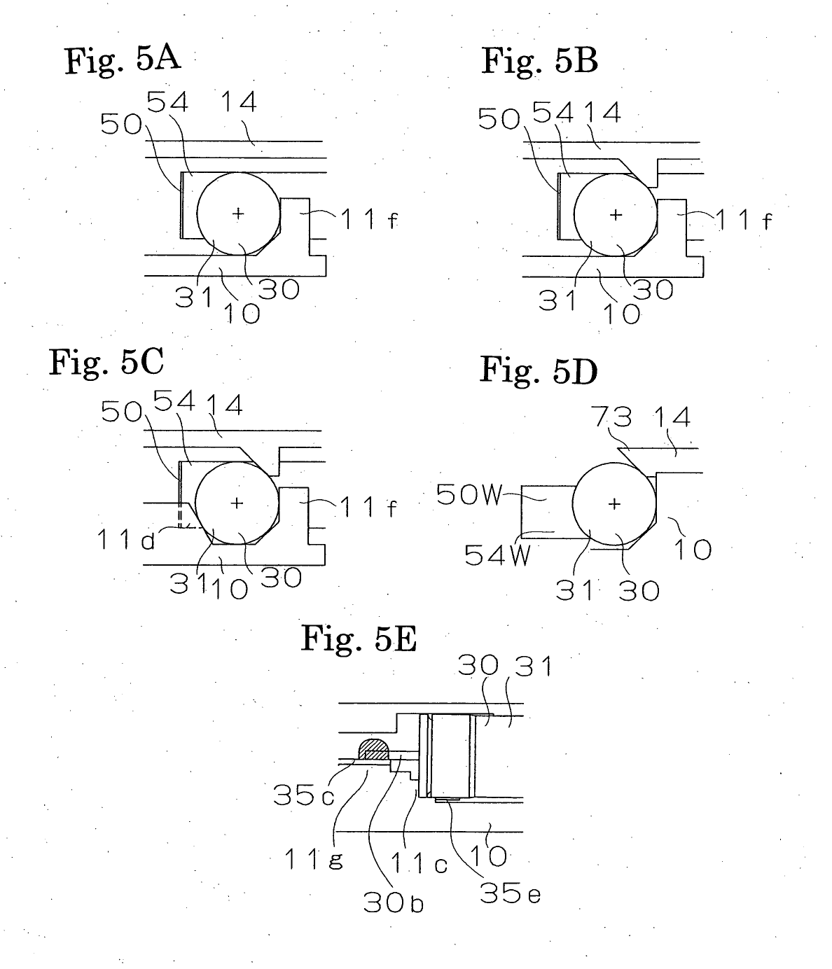

The main plate 10 is provided with recesses and projections and a surface shape suitable for arranging and supporting various timepiece elements to be positioned at respective positions of −Z side surface 10a of the main plate 10. The main plate 10 includes a side wall 11 (FIG. 2) having a winding stem guide hole 11a at a position on 3 o'clock side, and is provided with a quartz oscillator cabinet (quartz can) receiving projected portion 11f and a flexible circuit board mounting projected portion 11g projected at −Z side surface 10a as well as a clutch wheel receiving recess portion 11h formed at the surface 10a and a battery containing recess portion 11b specifying a portion of a peripheral wall by the side wall 11 or the like. A flexible circuit board mounting projected portion 11g is provided with a quartz oscillator cabinet (quartz can) end face receiving side wall portion 11c as described later in reference to FIG. 5E. Further, a reset pin 32 is implanted substantially in 5 o'clock direction of the hour hand in view from the center axis line C in the surface 10a of the main plate 10. The position of the reset pin 32 may be other position depending on arrangement and shape of a circuit board 34, mentioned later, or the like.

The winding stem 20 penetrating the winding stem guide hole 11a of the main plate 10 is provided with a square cylinder shape engaging shaft portion 22 at a front end, a cylindrical shape middle diameter shaft portion 23 at a middle, a cylindrical shape small diameter shaft portion 24 between the shaft portions 22, 23, an abacus bead shape portion 27 both sides in A1, A2 directions of which are specified by small diameter shaft portions 25, 26 in addition to a large diameter shaft portion 21 on a base end side, and is fitted to a clutch wheel 28. The clutch wheel 28 having a middle diameter hole portion on a base end side and a square cylinder shape hole portion on a front end (depth) side is disposed in the clutch wheel receiving recess portion 11h and is fitted to the winding stem 20 among the shaft portions 22, 24, 23. When the winding stem 20 is disposed at a 0-stage position (normal position) at which the winding stem 20 is pushed in A2 direction, the middle diameter hole portion and the square cylinder shape hole portion of the clutch wheel 28 are respectively fitted to the middle diameter portion 23 and the small diameter shaft portion 24 of the winding stem 20 rotatably. On the other hand, when the winding stem 20 is disposed at a 1-stage position (drawn position) at which the winding stem 20 is drawn by one stage in A1 direction, the square cylinder shape hole portion of the clutch wheel 28 is engaged with the square cylinder shape engaging shaft portion 22 of the front end of the winding stem 20 and the clutch wheel 28 is rotated in accordance with rotation of the winding stem 20 in B direction. The clutch wheel 28 is brought in mesh with an eighth wheel 15f at a wheel portion 28a at a front end thereof.

As is known from FIG. 1, FIG. 2, the train wheel mechanism 3 includes a top side train wheel 15 disposed between the main plate 10 and a portion of a train wheel bridge 14 disposed at an interval from the main plate 10 in −Z direction and a bottom side train wheel 16 disposed on +Z side of the main plate 10. The train wheel bridge 14 can be regarded as a portion of a machine frame similar to the main plate 10. The top side train wheel 15 includes a sixth wheel & pinion 15a, a fifth wheel & pinion 15b, a fourth wheel & pinion (second wheel & pinion) 15c, a third wheel & pinion 15d, a second wheel & pinion (minute wheel & pinion) 15e, and the eighth wheel 15f, and the bottom side train wheel 16 includes an hour wheel (hour wheel) 16a and an eighth pinion 16b. A shaft or a stem of the eighth wheel & pinion (minute wheel) 17 is extended to penetrate the main plate 10 in Z direction, the eighth wheel 15f is provided on a side of the top train wheel 115, and the eighth pinion 16b is provided on a side of the bottom side train wheel 16. A shaft portion of a shaft portion of the third wheel & pinion 15d proximate to the main plate 10 is fitted to a bearing hole 66a of a reset lever 60, mentioned later.

In FIG. 1, a motor 4 slender in Y direction is arranged at a position of the surface 10a of the main plate 10 on a side opposed to the winding stem 20, that is, on 9 o'clock side. In FIG. 1, on a right side of the winding stem 20 and the motor 4, a button type-battery 5 is arranged at the battery containing recess portion 11b specifying a portion of the peripheral wall. Further, in FIG. 1, on a left side of the winding stem 20 and the motor 4, there is arranged a circuit block 6 including a flexible circuit board 34 mounted with an IC (integrated circuit) 33 for a timepiece and a quartz oscillator 30. The board 34 is mounted with also a circuit part other than IC 33 as desired.

The motor 4 includes a stator 4a and a coil block 4b as well as a rotor 4c and a shaft of the rotor 4c is formed with a rotor pinion constituting the sixth wheel & pinion 15a. The coil block 4b of the motor 4 is electrically connected to the flexible circuit board 34 by an extended portion 4d of the winding.

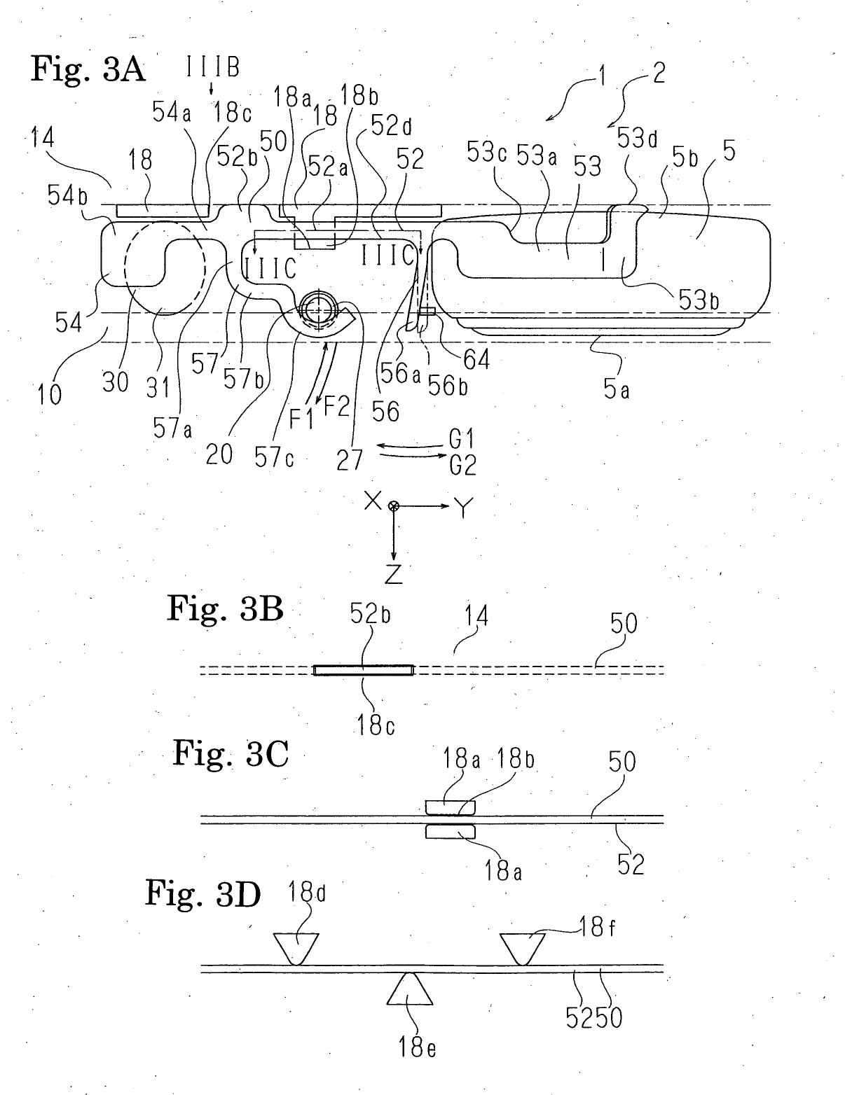

Notations 36a, 36b designate connecting portions for integrally connecting the stator 4a and the coil block 4b mechanically. At a location of the connecting portion 36a, the circuit board 34 is fixed to the motor 4 and at a location of the connecting portion 36b, a battery minus terminal 7 is fixed to the motor 4. The connecting portions 36a, 36b are provided with openings at centers thereof, projections projected from the main plate 10 are fitted and thermally calked to the openings, and a total of the motor 4, the circuit board 34 and the like is fixed to the main plate 10. The battery minus terminal 7 is extended to +Z side of the battery 5 along the surface 10a of the main plate 10 and is brought into contact with a negative pole 5a (FIG. 3A) at an end face of the battery 5 mounted on the surface 10a of the main plate 10. The battery minus terminal 7 is electrically connected to the circuit board 34 via the motor 4 (for example, a winding core insulated from the stator member 4a and the winding of the coil block 4b or the like) to provide a minus potential of the battery 5 to the circuit board 34. That is, a conductive portion per se of the part of the motor 4 constitutes an electricity feeding line on a minus side of a power source in corporation with the battery minus terminal 7.

An end portion on −Z side of the shaft portion of the rotor 4c of the motor 4 is rotatably supported by the train wheel bridge 14. The coil block 4b having a large diameter of the motor 4 is projected in −Z direction and may be loosely fitted into a corresponding notch or opening (not illustrated) of the train wheel bridge 14 or may be held by the train wheel bridge 14. Similarly, also the battery 5, having a high height in −Z direction is loosely fitted into a corresponding battery attaching and detaching opening (not illustrated) of the train wheel bridge 14. When a premise is constituted by using the battery 5 in service life range of the battery 5, the battery 5 may be pressed by the train wheel bridge 14.

At a center side side edge of the timepiece main body 2 in the surface on +Z side of the flexible circuit board 34 of the circuit block 6, a reset pin connecting conductive pad portion 35a is formed, and when the flexible circuit board 34 is mounted on the main plate projected portion 11g having a plane shape actually the same as that of the board 34 in the illustrated example, the conductive pad portion 35a is precisely brought into contact with −Z side end face (top face) of the reset pin 32. Naturally, the shape of the projected portion 11g may be different from that of the flexible circuit board 34 so far as the flexible circuit board 34 can be supported thereby by desired stability. Further, in a state of attaching the train wheel bridge 14, the train wheel bridge 14 presses the conductive pad portion 35a of the circuit board 34 to the top face of the reset pin 32. However, electric connection between the reset pin 32 and the circuit board 34 may be realized by a different mode.

The circuit block 6 is further formed with conductive patterns 35b, 35c, 35d and the conductive pattern 35d is attached with a connecting terminal piece portion 35e. The conductive pattern 35d is connected to an electricity feeding terminal of a power source voltage (potential) Vdd of IC 33 for the timepiece and the conductive patterns 35b, 35c are connected to terminals of the quartz oscillator 30. The conductive patterns 35b, 35c are electrically connected and fixed with a pair of connecting pins or connecting terminal portions 30a, 30b of the quartz oscillator 30 by soldering. The connecting terminal piece portion 35e electrically connected to the conducive pattern 35d at a base end thereof is extended along the surface 10a of the main plate 10 and is brought into contact with +Z side portion of a peripheral face of a conductive can, that is, a base end portion 31a of a quartz can 31 as a cabinet of the quartz oscillator 30 mounted on the surface 10a of the main plate 10. Further, a base portion side end face 31d of the quartz oscillator main body 31 is brought into contact with the quartz oscillator cabinet (quartz can) end face receiving side wall portion (side face portion) 11c of the flexible circuit board mounting projected portion 11g of the main plate 10 (FIG. 5E).

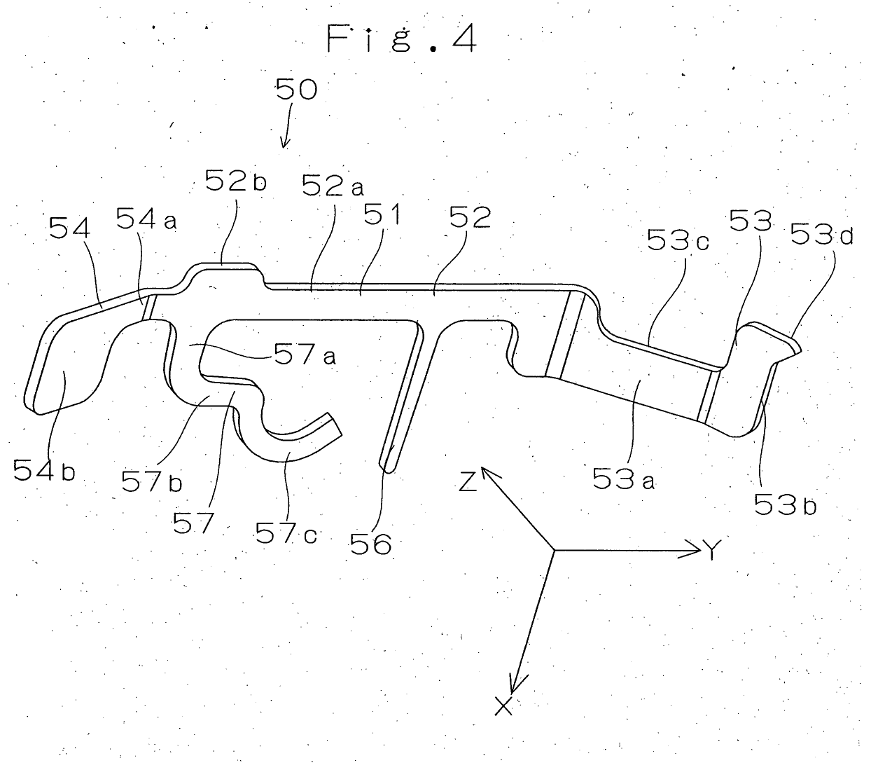

The train wheel bridge 14 is formed with a groove 18 (FIG. 2) as an engaging portion and a plate spring structure 50 made of a metal as a plate-like holding structure is locked by the groove 18. A main face or a surface of the plate spring structure 50 is orthogonal to an XY plane as shown by FIG. 3 and FIG. 4 in addition to FIG. 1 and FIG. 2. That is, a normal line relative to the main face of each portion of the plate spring structure 50 is disposed in a face in parallel with the XY plane regardless of the direction of the main face.

As is known from FIG. 1, FIG. 3 and FIG. 4, the plate spring structure 50 includes a main body portion 51 extended substantially in Y direction along the timepiece main body 2. The plate spring main body portion 51 is provided with a center portion 52 extended in Y direction, a battery plus pole contact terminal portion 53 as a battery holding portion which is extended from an end portion in +Y direction of the center portion 52 to −X side in a skewed direction by an obtuse angle relative to the center portion 52 and a front end of which is brought into press contact elastically with a peripheral face of the battery 5 constituting portion of a plus pole 5b of the battery 5, and a quartz can contact terminal portion 54 as an oscillator cabinet holding portion which is extended from −Y direction end portion of the center portion 52 to −X side in a skewed direction by an obtuse angle relative to the center portion 52 and a front end of which is brought into press contact elastically with a side edge 31c of a front end portion 31b of the quartz can 31 constituting the quartz oscillator cabinet. The plate spring structure 50 comprises a stainless steel alloy plate having a thickness of, for example, about 0.15 through 0.2 mm. Naturally, the thickness and the material may be different therefrom.

The battery plus pole contact terminal portion 53 includes an inclined arm portion 53a extended from an end portion in +Y direction of the center portion 52 to −X side in a skewed direction by an obtuse angle relative to the center portion 52, and a battery plus pole contact portion 53b further extended from a front end of the inclined arm portion 53a to −X side skewedly by an obtuse angle, and is brought into press contact with the battery plus pole 5b by a front end portion of the battery plus pole contact portion 53b. A fold-to-bend angle of the contact portion 53b relative to the center portion 52 is smaller than 90 degrees as a whole. According to the example, the center portion 52 is wide in a width thereof in Z direction at a vicinity of the end portion in +Y direction, and a side edge 53c on −Z side of the battery plus pole contact end portion 53 is partially notched. Further, the contact portion 53b of the front end of the battery plus pole contact end portion 53 ensures a wide contact region for the battery plus electrode 5b by providing a front end portion 53d rising in −Z direction and extended straight further frontward from the rising end portion (FIG. 3A).

The quartz can contact end portion 54 is provided with a slender arm portion 54a and a quartz can contact portion 54b formed at a front end portion of the arm portion 54a in a wide width in Z direction, and is brought into press contact with the side edge 31c of the front end portion 31b of the quartz can 31 at the contact portion 54b.

Therefore, the plate spring structure 50 functions as a battery plus terminal directly applying the voltage (potential) of the plus pole 5b of the battery 5 to a power source terminal IC 33 via the contact terminal piece portion 35e and the conductive pattern 35d constituting the electricity feeding line by being brought into contact with the plus electrode 5b of the battery 5 at the battery plus pole contact terminal portion 53 and brought into contact with the quartz can 31 at the quartz can contact terminal portion 54. In the above-described, the electricity feeding mechanism 9 is constituted by the plate spring structure 50 and the connecting terminal piece portion 35e.

In this case, the quartz can 31 per se is utilized as an electricity conducting path and therefore, in comparison with a case of connecting the plus pole 5b of the battery 5 and the power source terminal 35d of the circuit board 34 directly by a battery plus terminal, actually, a length of the plate spring structure 50 can be shortened by an amount of a length of the quartz can 31. Further, when a path of the battery plus terminal is going to be ensured at a location of the train wheel mechanism portion 3 having the train wheel, whereas not only a degree of freedom of layout of various parts is reduced but also it is necessary to constitute the battery plus terminal by a complicated plane shape or a complicated fold-to-bend shape, in this case, the plate spring structure 50 can be constituted by a comparatively simple shape.

Further, the plate spring structure 50 having the above-described structure and the shape is formed by being folded to bend in 90 degrees or less and in one direction as a whole relative to the center portion 52 and therefore, formation of a fold-to-bend die thereof and fold-to-bend operation can be carried out by minimum cost and time.

As shown by FIG. 3, the plate spring structure 50 is fitted to a groove 18b of a projected portion 18a of the engaging portion 18 of the train wheel bridge 14 (FIGS. 3A and 3C) at the center region 52a of the center portion 52 and is fitted to an opening portion 18c (FIGS. 3A and 3B) of the train wheel bridge 14 at a projected portion 52b formed at a side edge on −Z side of the center portion 52. Instead of forming the groove 18b for inserting the plate spring structure 50 at the projected portion 18a of the train wheel bridge 14 as shown by FIG. 3C, the plate spring structure 50 may be supported by forming in zigzag a plurality of projected portions 18d, 18e, 18f at the train wheel bridge 14 to form a narrow linear path and inserting a portion of the plate spring structure 50 (for example, center portion 52) among projected portions 18d, 18e, 18f to thread the projected portions 18d, 18e, 18f. The projected portion may be constituted by a cross-sectional shape to be brought into line contact with the plate spring structure 50 (line contact in a plane of FIG. 3D) as shown by FIG. 3D or may be a shape brought into face contact as in a side wall or the projected portion 18a constituting the groove 18b of FIG. 3C (line contact in a plane of FIG. 3C). Supporting of the plate spring structure 50 a shown by FIGS. 3A, 3C, 3D may be carried out by the main plate 10 in place of the train wheel bridge 14 or may be carried out by both of the train wheel bridge 14 and the main plate 10. The projected portions 18d, 18e, 18f may be constituted by pins made of a metal projected from the train wheel bridge 14 or the main plate 10 in place of resin members forming a base material of the train wheel bridge 14 or the main plate 10. The plate spring structure 50 may loosely be fitted in the groove portion 18b or among the projected portions 18d, 18e, 18f or may actually be supported thereby without play.

The plate spring structure 50 is constituted by a leaf spring extended in Y direction and having a width in Z direction as a whole and therefore, an area occupied in XY plane can be minimized. Further, terminal portions 53, 54 at both ends inserted through the groove portion 18b or the like can be held by actually constituting a fulcrum by a side wall of the groove portion 18b or the like by only being locked to be brought into press contact with the battery 5 and the quartz oscillator cabinet 31, a fixing structure of screwing, calking or the like is not needed and therefore, also a space necessary for holding the terminal portions 53, 54 can be minimized. Further, also the winding stem engaging spring portion 57 explained below can serve as a fulcrum.

The plate spring structure 50 further includes a reset lever deviating spring portion 56 and a winding stem engaging spring portion 57 projected from a side edge portion thereof on +Z side. The winding stem engaging spring portion 57 includes a base side arm portion 57a extended in +Z direction from the main body portion 51, a front end side arm portion 57b extended from an extended end of the base side arm portion 57a in +Y direction, and a circular arc shape engaging portion 57c extended from a front end of the arm portion 57b and is elastically engaged with the small diameter portion 25 or 26 at a vicinity of the abacus bead shape portion 27 of the winding stem 20 at the circular arc engaging portion 57c.

As is known from FIG. 1 and FIG. 3, the plate spring structure 50 is supported by the train wheel bridge 14 by being engaged with the engaging portion 18 of the train wheel bridge 14 at the center portion 52, the battery plus pole contact terminal portion 53 disposed at an end portion in +Y direction is brought into press contact elastically with a peripheral face of the plus pole 5b of the battery 5 in D direction, and the quartz can contact terminal portion 54 disposed at an end portion in −Y direction is brought into press contact elastically in E direction with the side edge 31c of the front end portion 31b of the quartz can 31 supported by the quartz oscillator cabinet receiving projected portion 11f and the quartz oscillator cabinet (quartz can) end face receiving side wall portion (side face portion) 11c of the main plate 10. Therefore, the plate spring structure 50 can elastically press the battery 5 and the quartz oscillator 30 by constituting a fulcrum by the engaging portion 18 of the train wheel bridge 14 and therefore, both of the battery 5 and the quartz oscillator 30 sizes of which are larger than those of other parts to be easy to deteriorate mounting stability can simultaneously and stably be positioned to fix. Further, the plate spring structure 50 is brought into contact with the battery 5 by large contact pressure at one end thereof and brought into contact with the quartz can 31 of the quartz oscillator 30 by large contact pressure at other end thereof and therefore, the plus potential of the battery 5 can firmly be conducted to the quartz can 31. Further, the quartz can 31 is connected to the power source voltage feeding terminal of IC 33 of the circuit block 6 via the contact terminal piece portion 35e and the conductive pattern 35d and therefore, the cabinet of the quartz oscillator 30, that is, the quartz can 31 can directly be utilized for supplying the power source voltage. The quartz oscillator cabinet portion or the quartz can 31 occupies large volume or area in the main body portion 2 of the electronic timepiece 1 and therefore, a length of the battery plus terminal can be minimized.

Further, the spring structure 50 exerts an elastic force in F1 direction to the winding stem 20 by being engaged with the small diameter portions 25, 26 on both sides of the abacus bead shape portion of the winding stem 20 at the circular arc shape engaging portion 57c of the winding stem engaging spring portion 57 and therefore, the winding stem 20 engaged elastically with the spring portion 57 by the small diameter portion 25 or 26 can elastically be held stably without being positionally shifted in A1, A2 direction and the winding stem 20 can be positioned. Further, since engagement between the spring portion 57 and the small diameter portion 25 or 26 is elastic engagement, for example, in the case in which the winding stem 20 is drawn in A1 direction when the winding stem 20 is disposed at 0-stage position and the circular arc shape engaging portion 57c of the spring portion 57 is engaged with the small diameter portion 25 of the winding stem 20, the abacus bead shape portion 27 is moved in A1 direction by elastically deforming the circular arc shape engaging portion 57c of the spring portion 57 to press down in F2 direction by the abacus bead shape portion 27 having a diameter larger than that of the small diameter portion 25. When the abacus bead shape portion 27 is passed through the spring portion 57 in A1 direction, the circular arc shape engaging portion 57c of the spring portion 57 is deformed again in F1 direction by an elastic recovery force and is fitted to the small diameter portion 26. Thereby, in drawing the winding stem 20 in A1 direction, the spring portion 57 of the spring structure 50 can provide a click feeling in corporation with the abacus bead shape portion 27. Also in pressing the winding stem 20 from winding stem 1 stage to winding stem 0 stage, the engaging portion 57c of the spring portion 57 is deformed to permit to pass the maximum diameter portion of the abacus bead shape portion 27 from the small diameter portion 26 and thereafter fitted to the small diameter portion 25 and therefore, a similar click feeling is provided.

Further, in supporting the spring portion 57 as described above, the spring structure 50 is not only held by the engaging portion 18 of the train wheel bridge 14 but also supported by the battery 5 and the quartz can 31 via the both end spring portions 53, 54 as reaction of elastically pressing the battery 5 and the quartz can 31 at the both end portions 53, 54 and therefore, support of the winding stem 20 can be stabilized in a stably held state. Further, in order to avoid the arm portions 57a, 57b of the winding stem engaging spring portion 57 from being considerably deformed in Y direction, restricting wall portions may be formed on +Y side and on −Y side of the arm portions 57a, 57b to interpose the arm portions 57a, 57b via gaps therebetween. The restricting wall portion may be a portion of the engaging portion 18 or the like.

Further, when desired, the surface 10a of the main plate 10 may be formed with a projected portion projected in −Z direction and the side edge portion 52d (FIG. 3) on +Z side of the center portion 52 of the spring structure 50 may be supported by the projected portion. In this case, the center portion 52 can firmly be prohibited from being displaced in +Z direction and therefore, the spring portion 57 can firmly provide the click feeling.

The electronic timepiece 1 is further provided with a reset lever 60 constituting the reset lever main body portion. According to the example, the reset lever 60 is provided with a plate-like portion 60a constituted by a drawn sheet metal member having a shape of a sea horse or the like as a whole, and a shaft portion 60b for rotatably supporting the plate-like portion 60a around a rotational center axis line C1 at a center portion relative to the main plate 10. The shaft portion 60b may rotatably be supported by a bearing hole of the main plate 10, or the plate-like portion 60a may be rotatable relative to the shaft portion 60b. The shaft portion 60b may further be supported by the main plate 10, or may be supported by the train wheel bridge 14 in place of the main plate 10.

The reset lever plate-like portion 60a includes an L-like shape arm portion 62 extended from a center boss portion or a fat portion 61 extended to a region including the rotation center axis line C1 to a front end of the winding stem 20, a spring receive portion or an engaging projected portion 63 projected from the boss portion 61 in X direction and engaged with the spring portion 56, an up and down direction arm portion 64 extended from the boss portion 61 substantially in −X direction, a transverse direction arm portion 65 extended substantially in −Y direction from an extended end of the up and down direction arm portion 64 extended slightly skewedly while avoiding the battery 5, a fat portion for a bearing of the third wheel & pinion or a boss portion 66 formed at a front end of the arm portion 65, and a reset terminal portion 67 skewedly extended from the boss portion 66 to a location of the reset pin 32. In the above-described, the boss portion 61 as well as the L-like shape arm portion 62 and the engaging projected portion 63 constitute an input side lever portion 68 and the arm portions 64, 65, 67 and the boss portion 66 constitute an output side lever portion 69. Further, in the above-described, the reset lever apparatus 8 is constituted by the reset lever 60, and the spring portion 56 of the plate spring structure 50.

When the winding stem 20 is disposed at winding stem 0 stage P0 pressed in A2 direction, a side edge 62b of a position detecting arm portion 62a on a front end side of the L-like shape arm portion 62 of the reset lever 60 is pressed in A2 direction from a front end face of the winding stem 20. Although in order to avoid the winding stem 20 from being exerted with an excessive A1 direction reaction force, the L-like shape arm portion 62 can more or less be flexed typically, the L-like arm portion 62 is provided with a rigidity far higher than that of the reset lever deviating spring portion 56 of the plate spring structure 50 and can substantially be regarded as a rigid body so far as the L-like shape arm portion 62 is compared with the spring portion 56.

When the winding stem 20 is disposed at the winding stem 0 stage P0 pressed in A2 direction, the spring receive portion or the engaging projected portion 63 of the reset lever 60 is pressed in −Y direction relative to a side edge 56b on +Y side of a front end portion 56a of the reset lever deviating spring portion 56 of the plate spring structure 50 to elastically deform the deviating spring portion 56 to shift the front end portion 56a of the reset lever deviating spring portion 56 in G1 direction (bold line of FIG. 3).

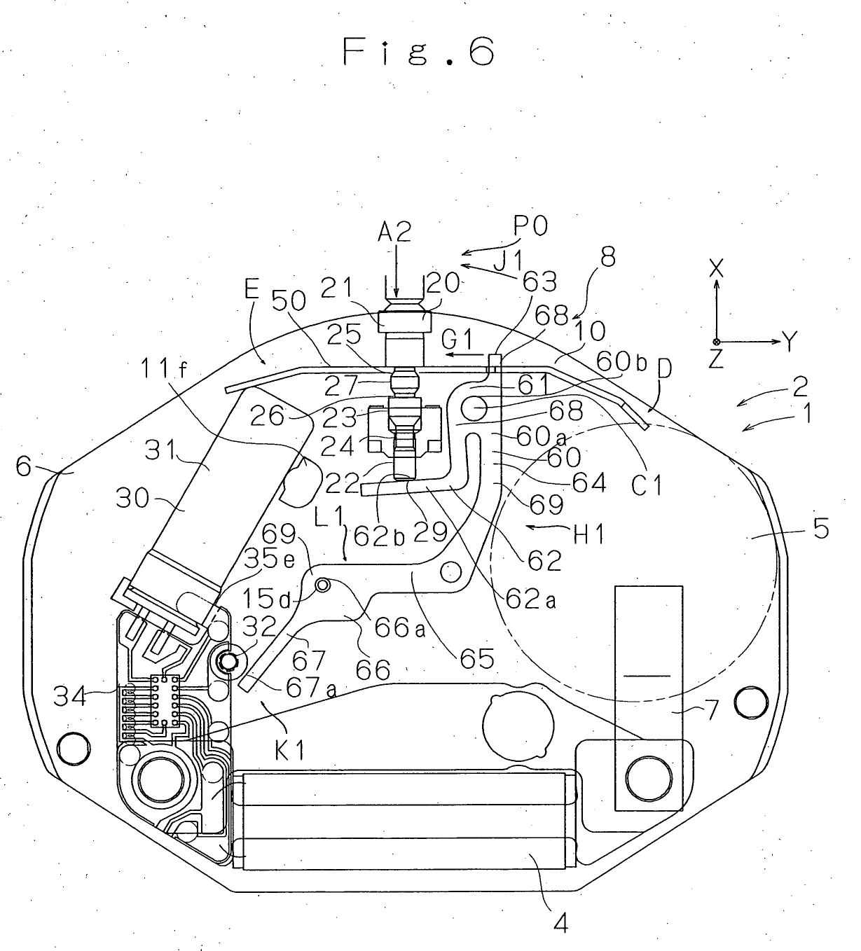

Therefore, when the winding stem 20 is disposed at the winding stem 0 stage, as shown by FIG. 6, the reset lever 60 adopts a nonreset position H1. That is, when the winding stem 20 is disposed at the winding stem 0 stage, the input side lever portion 68 presses the spring portion 56 of the plate spring structure 50 by being displaced to pivot in J1 direction under operation of the pressing force in A2 direction by the front end face 29 of the winding stem 20. Also the output side lever portion 69 of the reset lever 60 is displaced to pivot in J1 direction and the reset terminal portion 67 adopts a nonreset position K1 at which a side edge 67a of a front end thereof is separated from the reset pin 32. Further, when the reset lever 60 adopts the nonreset position H1, a third wheel & pinion support shaft bearing portion 66a adopts an engaging portion L1, the third wheel & pinion 15d is brought in mesh with the second wheel & pinion 15e to transmit rotation of the fourth wheel & pinion 15c to the second wheel & pinion 15e.

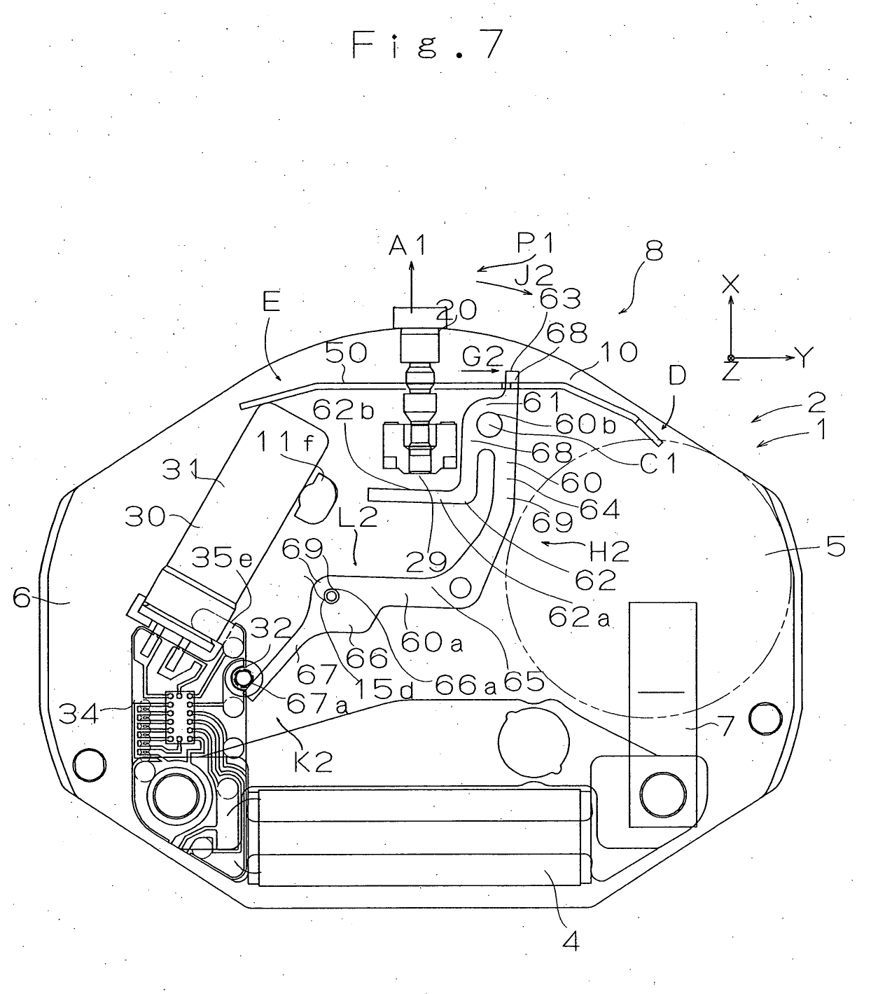

On the other hand, when as shown by FIG. 7, the winding stem 20 is drawn in A1 direction and adopts a winding stem 1 stage position P1, the front end face 29 of the winding stem 20 is moved in A1 direction, and is separated from the side edge 62b of the position detecting arm portion 62a of the L-like arm portion 62 of the reset lever 60. In accordance with releasing the force of displacing to pivot the input side lever portion 68 in J1 direction, by an elastic recovery force in G2 direction exerted to the projected portion 63 by the spring portion 56 of the plate spring structure 50, the input side lever portion 68 is pivoted in J2 direction around the center axis line C1. Therefore, also the output side lever portion 69 is displaced to pivot in J2 direction, and the reset terminal portion 67 is pressed to the reset pin 32 at the side edge portion 67a of the front end. That is, when the winding stem 20 is drawn in A1 direction and adopts the winding stem 1 stage position P1, the reset lever 60 adopts a reset position H2, and the reset terminal portion 67 is set to a reset position K2 at which the reset terminal portion 67 is brought into contact with the reset pin 32. As a result, supply of a signal for driving the motor 4 from the circuit block 6 is stopped, rotation of the motor 4 is stopped, and the rotation of the second hand 13c is stopped. Further, when the reset lever 60 adopts the reset position K2, the third wheel & pinion support bearing portion 66a adopts a nonengaging portion L2, the third wheel & pinion 15d and the second wheel & pinion 15e are released from being brought in mesh with each other, and rotation of the second wheel & pinion (minute wheel) 15e is not transmitted to the fourth wheel & pinion (second wheel) 15c. Further, by displacing by the third wheel & pinion support bearing portion 66a, instead of releasing the third wheel & pinion 15d and the second wheel & pinion 15e from being brought in mesh with each other, the third wheel & pinion 15d and the fourth wheel & pinion 15c may be released from being brought in mesh with each other.

When the third wheel & pinion 15d and the second wheel & pinion 15e are released from being brought in mesh with each other, even when rotation of the winding stem 20 for hand movement is transmitted from the clutch wheel 28 to the hour wheel (hour wheel) 16a and the second wheel & pinion (minute wheel) 15e via the minute wheel 17, rotation is not transmitted to the fourth wheel & pinion (second wheel & pinion) 15c and therefore, the minute hand 13b and the hour hand 13a can be set in a state of stopping the second hand 13c.

Further, instead of supporting the side face of the quartz oscillator cabinet (quartz can) 31 only by the quartz oscillator cabinet receiving projected portion 11f of the main plate 10 as shown by FIG. 5A, as shown by FIG. 5B, a projected portion 14a similar to the projected portion 11f may be formed also at the train wheel bridge 14 and the side face of the quartz oscillator cabinet 31 may be supported by the projected portion 14a. For example, when a position in Z direction of the plate spring structure 50 is disposed at the surface 10a of the main plate 10 comparatively remote from the contiguous surface portion, the quartz can 31 is easy to be held by supporting the quartz can 31 in this way. Further, as shown by FIG. 5D, the train wheel bridge 14 may be provided with an eaves shape receiving portion 73 and a side face of the quartz can 31 may positively be received by the eaves shape receiving portion 73. Further, in order to stably mount the quartz oscillator main body 31 at a vicinity of the quartz oscillator cabinet receiving projected portion 11f of the main plate 10 even in a state in which the pressing force by the leaf spring 50 is not exerted, as shown by FIG. 5C, a side wall portion 11d opposed to the quartz oscillator cabinet receiving projected portion 11f may further be formed in order to form a recess portion for mounting the oscillator main body 31 at the surface 10a of the main plate 10.

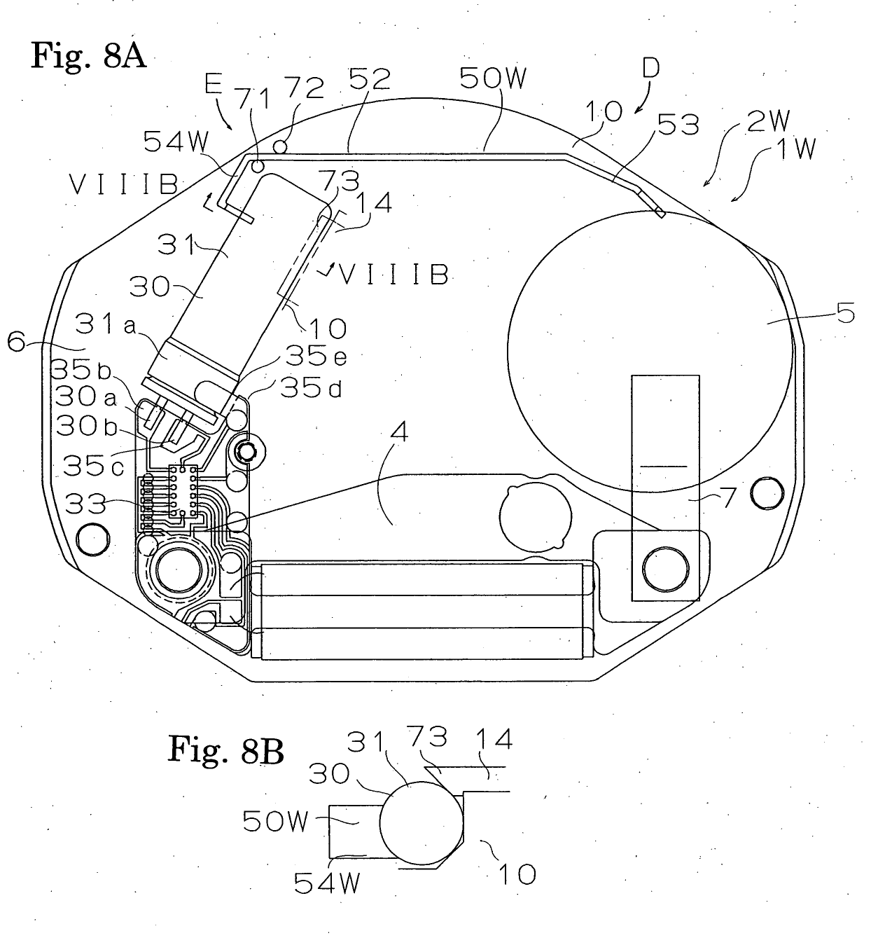

Further, the shape of the plate spring structure constituting a plate-like holding structure may differ so far as the plate spring structure is brought into press contact with the quartz can 31 and the plus pole 5b of the battery 5 at the quartz can contact terminal portion as a battery plus pole contact terminal portion and the battery plus pole contact terminal portion as a battery holding portion. FIG. 8 shows such a modified example. In the modified example shown in FIG. 8, members, portions or elements similar to those of FIG. 1 are attached with the same notations and portions which are changed therefrom are attached with added characters W at final portions of the same notations.

According to a plate spring structure 50W as a plate-like holding structure of an electronic timepiece 1W shown in FIG. 8, a quartz can contact terminal portion 54W is considerably folded to bend relative to the center portion 52 and a contact portion 54bW at a front end thereof is pressed to the quartz can 31. Further, the plate spring structure 50W is supported by pins 71, 72 implanted to the machine frame 10 or 14 at a vicinity of the quartz can contact terminal portion 54W of the center portion 52. According to the example, the pin 72 is operated as a fulcrum in a state of being brought into press contact with the quartz can 31 and the battery 5 at the contact terminal portions 54W, 53 at both ends thereof. Positions and numbers of the pins 71, 72 may differ.

Further, according to the electronic timepiece 1W of FIG. 8, as is known from FIG. 8B in addition to FIG. 8A, the train wheel bridge 14 is provided with the eaves shape receiving portion 73 and the side face of the quartz can 31 is received by the eaves shape receiving portion 73. Further, FIG. 8B corresponds to FIG. 5D.

It is apparent that in the electronic timepiece 1W constituted as described above, the plate spring structure 50W can function similar to the plate spring structure 50 shown in FIG. 1 and the like. The plate spring structure 50W may be provided with or may not be provided with the reset lever deviating spring portion 56 or the winding stem engaging spring portion 57.

What is claimed is:

1. A plate-like holding structure comprising:
a slender leaf spring as a whole mounted to a machine frame of a timepiece main body to be orthogonal to a main face of the timepiece main body and to be extended along a direction of extending the main face;
wherein the holding structure includes a battery holding portion brought into press contact with a battery at one end portion thereof and includes an oscillator cabinet holding portion brought into press contact with a cabinet of an oscillator at other end portion thereof and constituted such that a middle portion of the two holding portions is supported by a fulcrum portion supported by a machine frame main body.

2. A plate-like holding structure according to claim 1, wherein the middle portion is supported by the machine frame of the timepiece main body by being pinched by a groove portion or between projected portions of the machine frame of the timepiece main body.

3. A plate-like holding structure according to claim 1, wherein the middle portion includes a winding stem engaging portion engaged with a winding stem and is supported by the machine frame by way of the winding stem.

4. A plate-like holding structure according to claim 3, wherein the winding stem engaging portion is constituted by a winding stem positioning and engaging portion formed at one side edge of the middle portion, elastically engaged with a small diameter portion contiguous to an abacus bead shape portion having a large diameter of the winding stem and elastically deformed by the abacus bead shape portion to permit to pass through the abacus bead shape portion in bringing in and out the winding stem.

5. An electronic timepiece including the plate-like holding structure according to claim 1.

6. An electronic timepiece according to claim 5, further including a reset lever deviating spring portion for exerting a deviating force from a nonreset position to a reset position to a reset lever at one side edge thereof.
